(19) United States
(12) Patent Application Publication
(10) Pub. No.: US 2009/0116577 A1
(43) Pub. Date: May 7, 2009

(54) METHOD AND SYSTEM FOR MULTIPLE INPUT AND MULTIPLE OUTPUT CHANNEL ESTIMATION

(76) Inventors: Jose Maria Insenser Farre, Madrid (ES); Daniel Hernanz Chiloeches, Madrid (ES); Ruben Perez De Aranda Alonso, Madrid (ES); Carlos Parco Vidal, Madrid (ES)

Correspondence Address: Nixon Peabody LLP, 200 Page Mill Road, Suite 200, Palo Alto, CA, 94306, US

(21) Appl. No.: 12/353,258

(22) Filed: Jan. 14, 2009

Related U.S. Application Data
(63) Continuation of application No. PCT/ES2007/000395, filed on Jun. 29, 2007.

(30) Foreign Application Priority Data
Jul. 20, 2006 (ES) P200601942

(51) Int. Cl. H04B 7/02

(52) U.S. Cl. 375/267

(57) ABSTRACT

The invention relates to a method and system for multiple input and multiple output channel estimation, which can be used to generate and correlate sets of complementary sequences of length N, having a number of elements K greater than or equal to two. According to the invention, a block is used to generate sequences and to convolve same with an input signal, after which they are sent directly, or modulated, to the transmission channel. Once they have been received, and optionally demodulated, they pass through a correlator filter such as to obtain the input signal convolved by the channel, having a noise level reduced by factor KN.

### CROSS REFERENCE TO RELATED APPLICATIONS

This application is a continuation of PCT/ES2007/000395 filed Jun. 29, 2007, which claims priority to Spain Patent Application No. P200601942 filed Jul. 20, 2006, both of which are incorporated by reference herein.

### FIELD OF THE INVENTION

This invention relates to the method of generation and detection, as well as the optimal framework of pilot sequences to allow estimation of the timing and frequency characteristics of data transmission and reception systems in multiple input and multiple output channels, abbreviated in English as MIMO (Multiple Input Multiple Output).

### BACKGROUND

In recent years, the efforts to innovate and standardize the area of radio communications focused on MIMO techniques, the channel capacity of which increases proportionally according to the number of reception and transmission antennas, limited by estimation error [Yoo, T. and Goldsmith, A., “Capacity of Fading MIMO Channels with Channel Estimation Error,” IEEE Int. Conf. on Communications (ICC), Paris, France, June, 2004] of the channel impulse response matrix. Practical application of Complementary Sets of Sequences (CSS) was already successfully tested in environments such as: OFDM (orthogonal frequency-division multiplexing) for reducing the Peak-to-Average Ratio [B. Tarokh, “Construction of OFDM M-QAM Sequences with Low Peak-to-Average Power Ratio,” IEEE Trans. on Communications, vol. 51, no. 1, January 2003], MIMO Channel Estimation [S. Wang and A. Abdi, “Aperiodic complementary sets of sequences-based MIMO frequency selective channel estimation,” IEEE Commun. Lett., vol. 9, pp. 891-893, 2005], reduction of Multiple Access interference in CDMA (code division multiple access) environments [H. Chen, J. Yeh and N. Suehiro, “A multicarrier CDMA architecture based on orthogonal complementary codes for new generations of wideband wireless communications,” IEEE Commun. Mag., vol. 39, no. 10, pp. 126-135, October 2001], reduction of multitrajectory interference in UWB (Ultra Wide Band) [D. Wu, P. Spasojevic and I. Seskar, “Ternary Complementary Sets of Orthogonal Pulse Based UWB,” Proceedings of the 37^{th} Asilomar Conference on Signals, Systems and Computers, Vol. 2, pp 1776-1780, November 2003] and DSSS (direct-sequence spread spectrum) [Halford, K., Halford, S., Webster, M., and Andren, C., “Complementary Code Keying for RAKE-based indoor Wireless Communication,” Proceedings of the 1999 IEEE International Symposium on Circuits and Systems”].

A MIMO system provides a high gain in capacity by means of an increase in spatial dimensions. Nevertheless, the gain in capacity is reduced if the channel data is not perfect. In [A. Lapidoth and S. Moser, “Capacity bounds via duality with applications to multiple-antenna systems on flat-fading channels,” IEEE Trans. Inform. Theory, vol. 49, pp. 2426-2467, October 2003], it shows that in the absence of channel data, the MIMO capacity only increases double-logarithmically as a function of the SNR, and that the increase in spatial dimensions does not provide any benefit whatsoever. Under these circumstances, the MIMO system may achieve linear increments in capacity for practical SNR values provided that reasonable precision is obtained in the channel estimation.

According to [Spasojevic, P.; Georghiades, C. N. “Complementary sequences for ISI channel estimation,” IEEE Transactions on Information Theory, Volume: 47 Issue: 3, March 2001. pp 1145-1152], the optimal method is the use of Complementary Sets of Sequences (CSS). These sets of sequences allow obtaining the least possible variance in estimation error described by the Cramer-Rao lower bound (CRLB):

$${σ}_{E}^{2} = \frac{{N}_{o}}{{E}_{S}} \frac{L}{KN} \qquad < 1 >$$

where Es/No is the signal to noise ratio per symbol, L is the channel response length, K is the number of sequences of each set and N is the length of each sequence. This equation shows that the improvement in the estimation is proportional to the KN factor.

This method can be applied to traditional communication systems [Spasojevic, P.; Georghiades, C. N. “Complementary sequences for ISI channel estimation” IEEE Transactions on Information Theory, Volume: 47 Issue: 3, March 2001. pp 1145-1152] and MIMO systems [S. Wang and A. Abdi, “Aperiodic complementary sets of sequences-based MIMO frequency selective channel estimation,” IEEE Commun. Lett., vol. 9, pp. 891-893, 2005]. Both of the above-mentioned references use sets with two components (K=2), also called Golay sequences [MARCEL J. E. Golay “Complementary Series.” IRE Transactions on Information Theory, April 1961, pp. 82-87], but it is possible to work with K>2 [C.-C. Tseng, C. L. Liu, “Complementary Sets of Sequences,” IEEE Trans. Inform. Theory, Vol. IT-18, No. 5, pp. 644-651, September 1972].

The principal property of the CSS is:

$${\sum }_{i = 0}^{K - 1} {r}_{{a}_{i} {a}_{i}} [ n ] = KN δ [ n ] \qquad < 2 >$$

where rₓₓ is the aperiodic autocorrelation of x. The sum of the autocorrelation of all of the sequences of the set is equal to KN for n=0 and 0 for n≠O (Krönecker delta multiplied by the KN factor).

Another interesting property is that there are K sets of sequences that are mutually uncorrelated (also called “pairs” or orthogonal sets):

$${\sum }_{i = 0}^{K - 1} {r}_{{a}_{i} {b}_{i}} [ n ] = 0 , ∀ n \qquad < 3 >$$

This allows K sets to be transmitted simultaneously. In [S. Wang and A. Abdi, “Aperiodic complementary sets of sequences-based MIMO frequency selective channel estimation,” IEEE Commun. Lett., vol. 9, pp. 891-893, 2005], it is explained how the estimation may be made with two sets (K=2). For 5 MIMO systems with more than two transmission and reception antennas, this solution is not optimal because only 2 sets can be transmitted simultaneously and in order to transmit, it is necessary to leave open spaces in the frames, which causes an increase in length of the pilot sequences and reduces yield.

Golay sequences may be generated and detected efficiently by applying the systems defined in [S. Z. Budisin. “Efficient Pulse Compressor for Golay Complementary Sequences,” Elec. Lett. Vol. 27, No 3, pp. 219-220, Jan. 31, 1991] and [Popovic, B. M. Efficient Golay correlator.” Electronics Letters, Volume: 35, Issue: 17, Aug. 19, 1999 Pages: 1427-1428]. These structures are only valid for K=2.

In the structures defined in the preceding paragraph in order to make the correlation with a number of transmitters N_{T}, greater than two, and to obtain a perfect separation between data and training symbols, and to avoid interference between frames, it is necessary to insert “silences” in the frames by introducing zeros. The number of zeros is equal to:

$$Z = ( ⌈ \frac{{N}_{T}}{2} ⌉ - 1 ) ( L + 1 ) \qquad < 4 >$$

where L is the channel response length. The length in symbols of the 25 pilot sequences or training sequences of the frame required for channel estimation is equal to K(Z+N).

The proposed invention reduces the length of the pilots with respect to the prior method and proposes a new architecture to generate and detect/correlate CSCs with K≧2. The reduction is due to the fact that it is not necessary to insert zeros (Z=O) provided that K is equal to the number of transmission and reception antennas. For this, an architecture is necessary that allows generation and correlation of CSCs with K≧2.

Both the method proposed by [Popovic, B. M. “Efficient Golay correlator.” Electronics Letters, Volume: 35, Issue: 17, Aug. 19, 1999 Pages: 1427-1428] as well as the method proposed by [S. Wang and A. Abdi, “Aperiodic complementary sets of sequences-based MIMO frequency selective channel estimation,” IEEE Commun. Lett., vol. 9, pp. 891-893, 2005] are patented: [Popovic, Branislav, “Method and apparatus for efficient synchronization in spread spectrum Communications” PCT/SE00/00433] and [Shuangquan Wang and Ali Adbi, “Systems and/or Method for Channel Estimation in Communication Systems,” U.S. Provisional Patent Application No. 60/645,526. U.S. application Ser. No. 11/336,018] respectively. The current patent may be considered a patent that resolves the same problem as the patent of S. Wang, but more efficiently and in the case of the detection/correlation system, generalization of the method patented by B. Popovic for K greater than 2.

For sets of four sequences (K=4), a similar architecture has been described [F. J. Álvarez, et. al., “Efficient generator and pulse compressor for complementary sets of tour sequences.” IEEE Electronic Letters, vol. 40, no. 11, pp 703-704, May 2004] that cannot be considered as particularization of the algorithm proposed in this invention, since the order of operations and coefficients varies. The main advantage of the architecture proposed in this invention in relation to that of F. J. Álvarez is the possibility of changing K without changing the structure, thus being able to work in a single embodiment with several K, including only multiplexors, and in the proposal of F. J. Álvarez, the structure is designed specifically for K=4.

A previously patented method exists that describes how to transmit pairs of complementary sequences simultaneously using complex modulations [Vicente Díaz, “Method, transmitter and receiver for spread-spectrum digital communication by Golay complementary sequence modulation” PCT/ES01/00160 patent. Aug. 16, 2000. Granted in Spain as P200002086]. This method, unlike the one presented in this patent, is designed to modulate data with complementary sequences and not transmit preambles with K equal to the number of inputs and outputs of a MIMO system. Another difference is that the method is designed to transmit sequences with K=2 and not for K>2 as in this patent. This patent is also registered in the United States as [Vicente Díaz et al. “Device and Method for improving the signal to noise ratio by means of complementary sequences” U.S. patent application Ser. No. 10/832,138. Apr. 26, 2004].

The same occurs with the patent [Vicente Díaz et al. “Device and method for the optimal estimation of distortion of a transmission medium, comprising the sequential emission of pairs of quadrature complementary sequences,” Spanish Patent Application No. P200401299. May 4, 2004]. In this case, a general method is presented for estimation with K=2. No optimal algorithm is indicated for generation and correlation. No optimal method is indicated for MIMO systems. This patent is filed in the United States as [Vicente Díaz et al. “Device and Method for optimally estimating the transmission spectrum by means of the simultaneous modulation of complementary sequences.” U.S. patent application Ser. No. 10/835,843. Apr. 29, 2004.]

### SUMMARY

This invention relates to a method and system for precise estimation of a MIMO channel that allows the maximum capacity of said channel to be achieved.

This proposed invention is based on [S. Wang and A. Abdi, “Aperiodic complementary sets of sequences-based MIMO frequency selective channel estimation,” IEEE Commun. Lett, vol. 9, pp. 891-893, 2005], adding some improvements: increase K without changing the header frame or reducing the header frame without changing the KN factor and using a new system to allow CSCs with K greater than 2 to be generated and detected.

Generation of complementary sets of sequences is based on the general algorithm explained in the 7^{th} theorem of [Complementary Sets of Sequences, C. C. Tseng and C. L. Liu]:

With (_{jS}, 1≦j≦p) being a complementary set, H an orthogonal matrix q×p with elements hᵢⱼε{+1.0−1} and P|Q indicates concatenation of sequences, therefore:

$$( {S}_{1}^{h 11} \vert {S}_{2}^{h 12} \vert … \vert {S}_{p}^{h 1 p} , {S}_{1}^{h 21} \vert {S}_{2}^{h 22} \vert … \vert {S}_{p}^{h 2 p} , … , {S}_{1}^{hq 1} \vert … \vert {S}_{p}^{hqp} ) ≡ ( {\prod }_{j = 1}^{p} {S}_{j}^{hij} , 1 \leq i \leq q ) \qquad < 5 >$$

is a complementary set of q sequences.

The Hadamard matrices comply with the properties defined for H, and therefore may be used in the generation algorithm with the restriction that they are square matrices p=q. The generation of all sets of sequences that comply with these properties is based on the two possible matrices of the order 2×2:

$${H}_{1} = [ \begin{matrix}+ 1 & + 1 \\ + 1 & - 1\end{matrix} ] , {H}_{2} = [ \begin{matrix}+ 1 & - 1 \\ + 1 & + 1\end{matrix} ] \qquad < 6 >$$

Both matrices may be generated as:

$$H = [ \begin{matrix}+ 1 & + w \\ + 1 & - w\end{matrix} ] , ∀ \vert w \vert = 1 \qquad < 7 >$$

Matrices with a greater range that continue to comply with the properties of H may be generated as follows:

$${H}^{′} = H \times H = [ \begin{matrix}H & {w}^{′} H \\ H & - {w}^{′} H\end{matrix} ] , ∀ \vert {w}^{′} \vert = 1 \qquad < 8 >$$

For example, for a matrix p×p, the following matrix is obtained:

$$H = [ \begin{matrix}+ 1 & + {w}_{1} & + {w}_{2} & + {w}_{1} {w}_{2} & … & + {w}_{p} & + {w}_{1} {w}_{p} & … & + {w}_{1} {w}_{2} … {w}_{p} \\ + 1 & - {w}_{1} & + {w}_{2} & - {w}_{1} {w}_{2} & … & + {w}_{p} & - {w}_{1} {w}_{p} & … & - {w}_{1} {w}_{2} … {w}_{p} \\ + 1 & + {w}_{1} & - {w}_{2} & - {w}_{1} {w}_{2} & … & + {w}_{p} & + {w}_{1} {w}_{p} & … & - {w}_{1} {w}_{2} … {w}_{p} \\ + 1 & - {w}_{1} & - {w}_{2} & + {w}_{1} {w}_{2} & … & + {w}_{p} & - {w}_{1} {w}_{p} & … & + {w}_{1} {w}_{2} … {w}_{p} \\ ⋮ & ⋮ & ⋮ & ⋮ & … & ⋮ & ⋮ & ⋱ & ⋮ \\ + 1 & + {w}_{1} & + {w}_{2} & + {w}_{1} {w}_{2} & … & - {w}_{p} & - {w}_{1} {w}_{p} & … & - {w}_{1} {w}_{2} … {w}_{p} \\ + 1 & - {w}_{1} & + {w}_{2} & - {w}_{1} {w}_{2} & … & - {w}_{p} & + {w}_{1} {w}_{p} & … & + {w}_{1} {w}_{2} … {w}_{p} \\ + 1 & + {w}_{1} & - {w}_{2} & - {w}_{1} {w}_{2} & … & - {w}_{p} & - {w}_{1} {w}_{p} & … & + {w}_{1} {w}_{2} … {w}_{p} \\ + 1 & - {w}_{1} & - {w}_{2} & + {w}_{1} {w}_{2} & … & - {w}_{p} & + {w}_{1} {w}_{p} & … & - {w}_{1} {w}_{2} … {w}_{p}\end{matrix} ] \qquad < 9 >$$

The generation algorithm may be described iteratively, by extending the explanation in [S. Z. Budisin. “Efficient Pulse Compressor for Golay Complementary 5 Sequences.” Elec. Lett. Vol. 27, No 3, pp. 219-220, Jan. 31, 1991] to sets of K sequences, knowing that in each iteration n (0<n≦N) the coefficients wₓ may be modified, which are expressed as w_{x,n}. The length of the sequences generated is L=K^{N}. In order to obtain optimal architecture, the same idea of [S. Z. Budisin. “Efficient Pulse Compressor for Golay Complementary 5 Sequences.” Elec. Lett. Vol. 27, No. 3, pp. 219-220, Jan. 31, 1991] may be extended to sets of K=2^{p}≧2: the delay elements Dₙ are selected from the following set and in this order: {K^{N-1}, . . . , K¹, K⁰}. With these indications, the general algorithm is as follows:

$${c}_{1 , 0} [ i ] = {c}_{2 , 0} [ i ] = {c}_{3 , 0} [ i ] = … = {c}_{M , 0} [ i ] = δ [ i ] \\ {c}_{1 , n} [ i ] = {c}_{1 , n - 1} [ i ] + {w}_{1 , n} {c}_{2 , n - 1} [ i - {D}_{n} ] + {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … + {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] + … + {w}_{1 , n} {w}_{2 , n} … {w}_{p , n} {c}_{K , n - 1} [ i - ( K - 1 ) {D}_{n} ] \\ {c}_{2 , n} [ i ] = {c}_{1 , n - 1} [ i ] - {w}_{1 , n} {c}_{2 , n - 1} [ i - {D}_{n} ] + {w}_{2 , n} {c}_{3 , n - 1} [ i - 2 {D}_{n} ] - {w}_{1 , n} {w}_{2 , n} {c}_{4 , n - 1} [ i - 3 {D}_{n} ] + … + {w}_{p , n} {c}_{K , n - 1} [ i - ( K / 2 - 1 ) {D}_{n} ] - {w}_{1 , n} {w}_{p , n} {c}_{K , n - 1} [ i - ( K / 2 ) {D}_{n} ] - … - {w}_{1 , n} {w}_{2 , n} … {w}_{p , n} {c}_{K , n - 1} [ i - ( K - 1 ) {D}_{n} ] \\ {c}_{3 , n} [ i ] = {c}_{1 , n - 1} [ i ] + {w}_{1 , n} {c}_{2 , n - 1} [ i - {D}_{n} ] - {w}_{2 , n} {c}_{3 , n - 1} [ i - 2 {D}_{n} ] - {w}_{1 , n} {w}_{2 , n} {c}_{4 , n - 1} [ i - 3 {D}_{n} ] + … + {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] + … - {w}_{1 , n} {w}_{2 , n} … {w}_{p , n} {c}_{K , n - 1} [ i - ( K - 1 ) {D}_{n} ] \\ {c}_{4 , n} [ i ] = {c}_{1 , n - 1} [ i ] - {w}_{1 , n} {c}_{2 , n - 1} [ i - {D}_{n} ] - {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … + {w}_{p , n} {c}_{K , n - 1} [ i - ( K / 2 - 1 ) {D}_{n} ] - {w}_{1 , n} {w}_{p , n} {c}_{K , n - 1} [ i - ( K / 2 ) {D}_{n} ] + … + {w}_{1 , n} {w}_{2 , n} … {w}_{p , n} {c}_{K , n - 1} [ i - ( K - 1 ) {D}_{n} ] \\ … \\ {c}_{K , n} [ i ] = {c}_{1 , n - 1} [ i ] - {w}_{1 , n} {c}_{2 , n - 1} [ i - {D}_{n} ] - {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … - {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] - … - {w}_{1 , n} {w}_{2 , n} … {w}_{p , n} {c}_{K , n - 1} [ i - ( K - 1 ) {D}_{n} ] \qquad < 10 >$$

where {c_{1, n}, c_{2, n}, c_{3, n}, c_{3, n}, . . . c_{M, n}} represents four complementary sequences with length L=K^{N}, δ[i] is the Kronecker delta and n (0<n≦N) the iteration number.

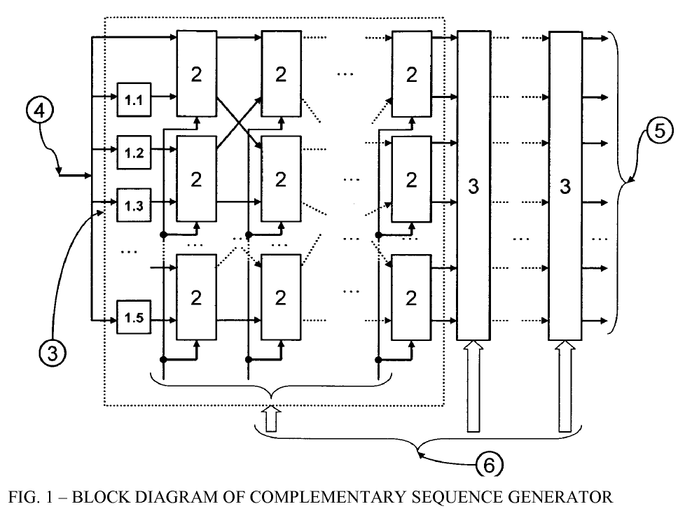

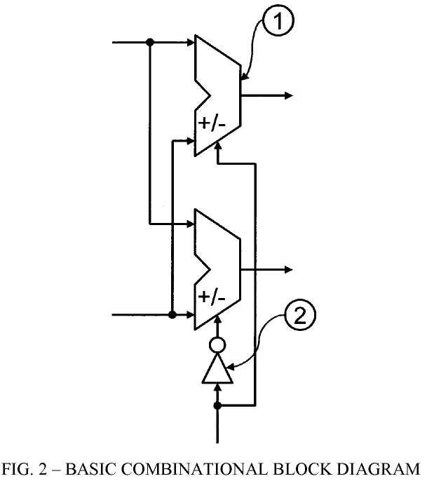

The block diagram (see FIG. 1) of the system that allows this algorithm to be generated is obtained by applying the transformed Z to the above-mentioned expressions, thus obtaining a lattice system with N identical phases, one of which has K−1 FIFO (First-Input First-Output) memory and Klog₂K addition or subtraction operations. The addition or subtraction operations are grouped by 2 in a functional block (see FIG. 2).

$${C}_{1 , 0} = {C}_{2 , 0} = {C}_{3 , 0} = … = {C}_{M , 0} = 1 \\ {C}_{1 , n} [ z ] = {C}_{1 , n - 1} [ z ] + {w}_{1 , n} {C}_{2 , n - 1} [ z ] {z}^{- {D}_{n}} + {w}_{2 , n} {C}_{3 , n - 1} [ z ] {z}^{- 2 {D}_{n}} + {w}_{1 , n} {w}_{2 , n} {C}_{4 , n - 1} [ z ] {z}^{- 3 {D}_{n}} + … + {w}_{p , n} {C}_{K , n - 1} [ z ] {z}^{- ( K / 2 - 1 ) {D}_{n}} + {w}_{1 , n} {w}_{p , n} {C}_{K , n - 1} [ z ] {z}^{- ( K / 2 ) {D}_{n}} + … + {w}_{1 , n} {w}_{2 , n} … {w}_{p , n} {C}_{K , n - 1} [ z ] {z}^{- ( K - 1 ) {D}_{n}} \\ {C}_{2 , n} [ z ] = {C}_{1 , n - 1} [ z ] - {w}_{1 , n} {C}_{2 , n - 1} [ z ] {z}^{- {D}_{n}} + {w}_{2 , n} {C}_{3 , n - 1} [ z ] {z}^{- 2 {D}_{n}} - {w}_{1 , n} {w}_{2 , n} {C}_{4 , n - 1} [ z ] {z}^{- 3 {D}_{n}} + … + {w}_{p , n} {C}_{K , n - 1} [ z ] {z}^{- ( K / 2 - 1 ) {D}_{n}} - {w}_{1 , n} {w}_{p , n} {C}_{K , n - 1} [ z ] {z}^{- ( K / 2 ) {D}_{n}} - … - {w}_{1 , n} {w}_{2 , n} … {w}_{p , n} {C}_{K , n - 1} [ z ] {z}^{- ( K - 1 ) {D}_{n}} \\ {C}_{3 , n} [ z ] = {C}_{1 , n - 1} [ z ] + {w}_{1 , n} {C}_{2 , n - 1} [ z ] {z}^{- {D}_{n}} - {w}_{2 , n} {C}_{3 , n - 1} [ z ] {z}^{- 2 {D}_{n}} - {w}_{1 , n} {w}_{2 , n} {C}_{4 , n - 1} [ z ] {z}^{- 3 {D}_{n}} + … + {w}_{p , n} {C}_{K , n - 1} [ z ] {z}^{- ( K / 2 - 1 ) {D}_{n}} + {w}_{1 , n} {w}_{p , n} {C}_{K , n - 1} [ z ] {z}^{- ( K / 2 ) {D}_{n}} - … - {w}_{1 , n} {w}_{2 , n} … {w}_{p , n} {C}_{K , n - 1} [ z ] {z}^{- ( K - 1 ) {D}_{n}} \\ {C}_{4 , n} [ z ] = {C}_{1 , n - 1} [ z ] - {w}_{1 , n} {C}_{2 , n - 1} [ z ] {z}^{- {D}_{n}} - {w}_{2 , n} {C}_{3 , n - 1} [ z ] {z}^{- 2 {D}_{n}} + {w}_{1 , n} {w}_{2 , n} {C}_{4 , n - 1} [ z ] {z}^{- 3 {D}_{n}} + … + {w}_{p , n} {C}_{K , n - 1} [ z ] {z}^{- ( K / 2 - 1 ) {D}_{n}} - {w}_{1 , n} {w}_{p , n} {C}_{K , n - 1} [ z ] {z}^{- ( K / 2 ) {D}_{n}} + … + {w}_{1 , n} {w}_{2 , n} … {w}_{p , n} {C}_{K , n - 1} [ z ] {z}^{- ( M - 1 ) {D}_{n}} \\ … \\ {C}_{K , n} [ z ] = {C}_{1 , n - 1} [ z ] - {w}_{1 , n} {C}_{2 , n - 1} [ z ] {z}^{- {D}_{n}} - {w}_{2 , n} {C}_{3 , n - 1} [ z ] {z}^{- 2 {D}_{n}} + {w}_{1 , n} {w}_{2 , n} {C}_{4 , n - 1} [ z ] {z}^{- 3 {D}_{n}} + … - {w}_{p , n} {C}_{K , n - 1} [ z ] {z}^{- ( K / 2 - 1 ) {D}_{n}} + {w}_{1 , n} {w}_{p , n} {C}_{K , n - 1} [ z ] {z}^{- ( K / 2 ) {D}_{n}} - … - {w}_{1 , n} {w}_{2 , n} … {w}_{p , n} {C}_{K , n - 1} [ z ] {z}^{- ( K - 1 ) {D}_{n}} \qquad < 11 >$$

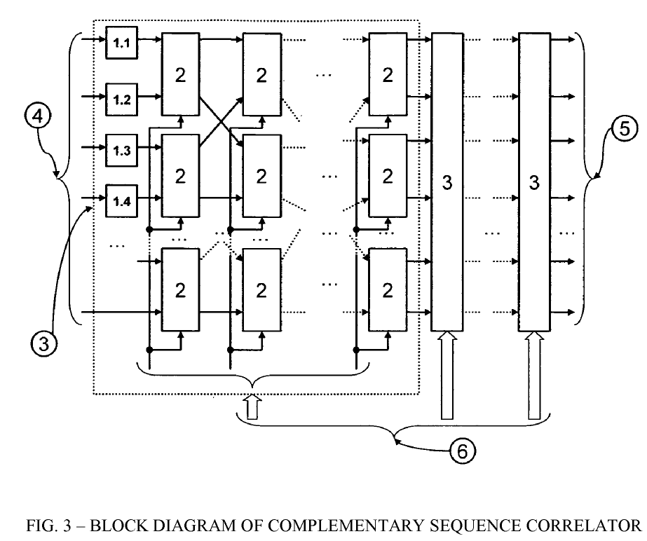

If the original algorithm is modified to generate the reflected sequences {c′_{1, n}, c′_{2, n}, c′_{3, n}, c′_{3, n}, . . . c′_{M, n},} by extending to sets of K sequences the same idea as in [Popovic, Branislav, “Method and apparatus for efficient synchronization in spread spectrum Communications” PCT/SE00/00433] for K≧2, the correlator or matched filter is obtained (see FIG. 3) which allows correlation of sequences to be obtained efficiently. The correlator system may also be used as a generator. In this case, the generator filter described above will be used as a matched filter. The analytical expression for the matched filter or correlator is:

$${C}_{1 , n} [ z ] = {C}_{1 , n - 1} [ z ] {z}^{- ( K - 1 ) {D}_{n}} + {w}_{1 , n} {C}_{2 , n - 1} [ z ] {z}^{- ( K - 2 ) {D}_{n}} + {w}_{2 , n} {C}_{3 , n - 1} [ z ] {z}^{- ( K - 3 ) {D}_{n}} + {w}_{1 , n} {w}_{2 , n} {C}_{4 , n - 1} [ z ] {z}^{- ( K - 3 ) {D}_{n}} + … … + {w}_{p , n} {C}_{K , n - 1} [ z ] {z}^{- ( k / 2 - 2 ) {D}_{n}} + {w}_{1 , n} {w}_{p , n} {C}_{K , n - 1} [ z ] {z}^{- ( K / 2 - 3 ) {D}_{n}} + … … + {w}_{1 , n} {w}_{2 , n} … {w}_{p , n} {C}_{K , n - 1} [ z ] \\ {C}_{2 , n} [ z ] = {C}_{1 , n - 1} [ z ] {z}^{- ( K - 1 ) {D}_{n}} - {w}_{1 , n} {C}_{2 , n - 1} [ z ] {z}^{- ( K - 2 ) {D}_{n}} + {w}_{2 , n} {C}_{3 , n - 1} [ z ] {z}^{- ( K - 3 ) {D}_{n}} - {w}_{1 , n} {w}_{2 , n} {C}_{4 , n - 1} [ z ] {z}^{- ( K - 3 ) {D}_{n}} + … … + {w}_{p , n} {C}_{K , n - 1} [ z ] {z}^{- ( k / 2 - 2 ) {D}_{n}} + {w}_{1 , n} {w}_{p , n} {C}_{K , n - 1} [ z ] {z}^{- ( K / 2 - 3 ) {D}_{n}} + … … - {w}_{1 , n} {w}_{2 , n} … {w}_{p , n} {C}_{K , n - 1} [ z ] \\ {C}_{3 , n} [ z ] = {C}_{1 , n - 1} [ z ] {z}^{- ( K - 1 ) {D}_{n}} + {w}_{1 , n} {C}_{2 , n - 1} [ z ] {z}^{- ( K - 2 ) {D}_{n}} - {w}_{2 , n} {C}_{3 , n - 1} [ z ] {z}^{- ( K - 3 ) {D}_{n}} - {w}_{1 , n} {w}_{2 , n} {C}_{4 , n - 1} [ z ] {z}^{- ( K - 3 ) {D}_{n}} + … … + {w}_{p , n} {C}_{K , n - 1} [ z ] {z}^{- ( k / 2 - 2 ) {D}_{n}} + {w}_{1 , n} {w}_{p , n} {C}_{K , n - 1} [ z ] {z}^{- ( K / 2 - 3 ) {D}_{n}} - … … - {w}_{1 , n} {w}_{2 , n} … {w}_{p , n} {C}_{K , n - 1} [ z ] \\ {C}_{4 , n} [ z ] = {C}_{1 , n - 1} [ z ] {z}^{- ( K - 1 ) {D}_{n}} - {w}_{1 , n} {C}_{2 , n - 1} [ z ] {z}^{- ( K - 2 ) {D}_{n}} - {w}_{2 , n} {C}_{3 , n - 1} [ z ] {z}^{- ( K - 3 ) {D}_{n}} + {w}_{1 , n} {w}_{2 , n} {C}_{4 , n - 1} [ z ] {z}^{- ( K - 3 ) {D}_{n}} + … … + {w}_{p , n} {C}_{K , n - 1} [ z ] {z}^{- ( k / 2 - 2 ) {D}_{n}} - {w}_{1 , n} {w}_{p , n} {C}_{K , n - 1} [ z ] {z}^{- ( K / 2 - 3 ) {D}_{n}} + … … + {w}_{1 , n} {w}_{2 , n} … {w}_{p , n} {C}_{K , n - 1} [ z ] \\ … \\ {C}_{M , n} [ z ] = {C}_{1 , n - 1} [ z ] {z}^{- ( K - 1 ) {D}_{n}} - {w}_{1 , n} {C}_{2 , n - 1} [ z ] {z}^{- ( K - 2 ) {D}_{n}} - {w}_{2 , n} {C}_{3 , n - 1} [ z ] {z}^{- ( K - 3 ) {D}_{n}} + {w}_{1 , n} {w}_{2 , n} {C}_{4 , n - 1} [ z ] {z}^{- ( K - 3 ) {D}_{n}} - … … - {w}_{p , n} {C}_{K , n - 1} [ z ] {z}^{- ( k / 2 - 2 ) {D}_{n}} + {w}_{1 , n} {w}_{p , n} {C}_{K , n - 1} [ z ] {z}^{- ( K / 2 - 3 ) {D}_{n}} - … … - {w}_{1 , n} {w}_{2 , n} … {w}_{p , n} {C}_{K , n - 1} [ z ] \\ \qquad < 12 >$$

For response detection, it is necessary to add the correlations.

### BRIEF DESCRIPTION OF DRAWINGS

FIG. 1 shows the structure of the complementary sequences generator. The various components are detailed below:
1. Delay elements. Each of them is different, and their delay is defined according to expression <11>.
2. Basic combinational block described in FIG. 2.
3. Basic generator phase.
4. Input of signal to be convoluted.
5. Output of complementary sequences.
6. Input of coefficients.

FIG. 2 shows the structure of the basic combinational block:
1. Addition/subtraction element. It performs the addition of the input signals.
2. Inversion element. It changes the sign of the input signal.

FIG. 3 shows the structure of the complementary sequences generator. The various components are detailed below:
1. Delay elements. Each of them is different, and their delay is defined according to expression <12>.
2. Basic combinational block described in FIG. 2.
3. Basic correlator phase.
4. Input of signal to be convoluted.
5. Output of complementary sequences.
6. Input of coefficients.

1. A method for generating complementary sets of sequences, comprising:
convoluting complementary sequences with any signal using a filter;
adding outputs of generators and simultaneously transmitting sets of complementary sequences using an addition block; and
multiplexing, using a multiplexer block, the sequences generated with the data to be transmitted.

2. A method to detect or correlate complementary sets of sequences comprising:
Using a matched filter to make the correlation with complementary sets of sequences transmitted;
Using an addition block for adding the correlations; and
Using a detection block for estimation or storage of the channel response.

3. The method according to claim 1 wherein each complementary sequence has an autocorrelation with minimum side lobes and a maximum main lobe for a null delay of said complementary sequence.

4. The method according to claim 1 that further includes:
using the autocorrelation values to estimate the timing and frequency response of the means of transmission.

5. The method according to claim 1 wherein all of the complementary sets of sequences are generated simultaneously.

6. The method according to claim 2 wherein all of the complementary sets of sequences are correlated simultaneously.

7. The method according to claim 1 wherein all of the complementary sets of sequences are generated recursively.

8. The method according to claim 2 wherein all of the complementary sets of sequences are correlated recursively.

9. The method according to claim 1 wherein all of the complementary sets of sequences are generated iteratively.

10. The method according to claim 2 wherein all of the complementary sets of sequences are correlated iteratively.

11. The method according to claim 1 wherein a transmitter for the transmitting is a base station and a receiver is a mobile or fixed device, and wherein the complementary sequences are used as part of the frame of data transmitted from the base station to the receiver or vice versa.

12. The method according to claim 1 wherein a transmitter for the transmitting is a modem and a receiver is another modem, and wherein the complementary sequences are used as part of the frame of data transmitted from the base station to the receiver or vice versa.

13. The method according to claim 1 wherein a transmitter for the transmitting is a sonar/radar system and a receiver is another sonar/radar system, and wherein the complementary sequences are used as the sequence transmitted to detect the target or its properties.

14. The method according to claim 1 wherein a transmitter for transmitting and a receiver are the same sonar/radar system, and wherein the complementary sequences are used as the sequence transmitted to detect the target or its properties.

15. The method according to claim 1 wherein the transmitted sequences are complementary sequences, which are understood to be sequences with correlation, the total of whose aperiodic autocorrelations is zero for any movement except for null movement.

16. The method according to claim 13 wherein each complementary sequence is generated by concatenating a pair of smaller sequences.

17. The method according to claim 11 wherein the result of detection or correlation is used as a timing reference to synchronize the system.

18. The method according to claim 1 wherein the transmitted sequences are generated according to the following algorithm:
$${c}_{1 , 0} [ i ] = {c}_{2 , 0} [ i ] = {c}_{3 , 0} [ i ] = … = {c}_{M , 0} [ i ] = δ [ i ]$$
$${c}_{1 , n} [ i ] = {c}_{1 , n - 1} [ i ] + {w}_{1 , n} {c}_{2 , n - 1} [ i - {D}_{n} ] + {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] + … … + {w}_{1 , n} {w}_{2 , n} … {w}_{p , n} {c}_{K , n - 1} [ i - ( K - 1 ) {D}_{n} ] \\ {c}_{2 , n} [ i ] = {c}_{1 , n - 1} [ i ] - {w}_{1 , n} {c}_{2 , n - 1} [ i - {D}_{n} ] + {w}_{2 , n} {c}_{3 , n - 1} [ i - 2 {D}_{n} ] - {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] - {w}_{1 , n} {w}_{p , n} {c}_{K , n - 1} [ i - ( K / 2 ) {D}_{n} ] - … … - {w}_{1 , n} {w}_{2 , n} … {w}_{p , n} {c}_{K , n - 1} [ i - ( K - 1 ) {D}_{n} ] \\ {c}_{3 , n} [ i ] = {c}_{1 , n - 1} [ i ] + {w}_{1 , n} {c}_{2 , n - 1} [ i - {D}_{n} ] - {w}_{2 , n} {c}_{3 , n - 1} [ i - 2 {D}_{n} ] - {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] + … … - {w}_{1 , n} {w}_{2 , n} … {w}_{p , n} {c}_{K , n - 1} [ i - ( K - 1 ) {D}_{n} ] \\ {c}_{4 , n} [ i ] = {c}_{1 , n - 1} [ i ] - {w}_{1 , n} {c}_{2 , n - 1} [ i - {D}_{n} ] - {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] - {w}_{1 , n} {w}_{p , n} {c}_{K , n - 1} [ i - ( K / 2 ) {D}_{n} ] + … … + {w}_{1 , n} {w}_{2 , n} … {w}_{p , n} {c}_{K , n - 1} [ i - ( K - 1 ) {D}_{n} ] \\ … \\ {c}_{K , n} [ i ] = {c}_{1 , n - 1} [ i ] - {w}_{1 , n} {c}_{2 , n - 1} [ i - {D}_{n} ] - {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … … - {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] - … … - {w}_{1 , n} {w}_{2 , n} … {w}_{p , n} {c}_{K , n - 1} [ i - ( K - 1 ) {D}_{n} ]$$
Where i=0, 1, 2, 3, . . . , 2^{N}−1; n=1, 2, . . . N; Dₙ=K^{P}^{ₙ}; K=2^{p} is the maximum number of complementary sets of orthogonal sequences among them; {c_{1,n}[i], c_{2,n}[i], . . . c_{K,n}[i]} are a set of complementary sequences with a length 2^{N}; δ[i] is the Kronecker delta function; i is a whole number that represents the scale of time; n is the iteration number, Dₙ is a delay element, Pₙ, n=1, 2, . . . , 2^{N}, is any permutation of the numbers {0, 1, 2, . . . , N−1}; and {w_{1,n}, w_{2,n}, . . . , w_{p,n}} are P vectors of coefficients with length N where each w_{x,y} is an arbitrary unit magnitude complex number;

19. The method according to claim 1 wherein the transmitted sequences are generated according to the following algorithm:
$${c}_{1 , 0} [ i ] = {c}_{2 , 0} [ i ] = {c}_{3 , 0} [ i ] = … = {c}_{M , 0} [ i ] = δ [ i ]$$
$${c}_{1 , n} [ i ] = {c}_{1 , n - 1} [ i ] + {w}_{1 , n} {c}_{2 , n - 1} [ i - ( K - 1 ) {D}_{n} ] + {w}_{2 , n} {c}_{3 , n - 1} [ i - ( K - 2 ) {D}_{n} ] + {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] + {w}_{1 , n} {w}_{p , n} {c}_{K , n - 1} [ i - ( K / 2 - 3 ) {D}_{n} ] + … … + {w}_{1 , n} {w}_{2 , n} … {w}_{p , n} {c}_{K , n - 1} [ i ]$$
$${c}_{2 , n} [ i ] = {c}_{1 , n - 1} [ i ] - {w}_{1 , n} {c}_{2 , n - 1} [ i - ( K - 1 ) {D}_{n} ] + {w}_{2 , n} {c}_{3 , n - 1} [ i - ( K - 2 ) {D}_{n} ] - {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] - {w}_{1 , n} {w}_{p , n} {c}_{K , n - 1} [ i - ( K / 2 - 3 ) {D}_{n} ] - … … - {w}_{1 , n} {w}_{2 , n} … {w}_{p , n} {c}_{K , n - 1} [ i ]$$
$${c}_{3 , n} [ i ] = {c}_{1 , n - 1} [ i ] + {w}_{1 , n} {c}_{2 , n - 1} [ i - ( K - 1 ) {D}_{n} ] - {w}_{2 , n} {c}_{3 , n - 1} [ i - ( K - 2 ) {D}_{n} ] - {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] + {w}_{1 , n} {w}_{p , n} {c}_{K , n - 1} [ i - ( K / 2 - 3 ) {D}_{n} ] + … … - {w}_{1 , n} {w}_{2 , n} … {w}_{p , n} {c}_{K , n - 1} [ i ]$$
$${c}_{4 , n} [ i ] = {c}_{1 , n - 1} [ i ] - {w}_{1 , n} {c}_{2 , n - 1} [ i - ( K - 1 ) {D}_{n} ] - {w}_{2 , n} {c}_{3 , n - 1} [ i - ( K - 2 ) {D}_{n} ] + {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] - {w}_{1 , n} {w}_{p , n} {c}_{K , n - 1} [ i - ( K / 2 - 3 ) {D}_{n} ] + … … + {w}_{1 , n} {w}_{2 , n} … {w}_{p , n} {c}_{K , n - 1} [ i ]$$
$$…$$
$${c}_{K , n} [ i ] = {c}_{1 , n - 1} [ i ] - {w}_{1 , n} {c}_{2 , n - 1} [ i - ( K - 1 ) {D}_{n} ] - {w}_{2 , n} {c}_{3 , n - 1} [ i - ( K - 2 ) {D}_{n} ] + {w}_{1 , n} {w}_{2 , n} {c}_{4 , n - 1} [ i - ( K - 3 ) {D}_{n} ] + … … - {w}_{p , n} {c}_{K , n - 1} [ i - ( K / 2 - 2 ) {D}_{n} ] + {w}_{1 , n} {w}_{p , n} {c}_{K , n - 1} [ i - ( K / 2 - 3 ) {D}_{n} ] - … … - {w}_{1 , n} {w}_{2 , n} … {w}_{p , n} {c}_{K , n - 1} [ i ]$$
where i=0, 1, 2, 3, . . . , 2^{N}−1; n=1, 2, . . . N; Dₙ=K^{P}^{ₙ}; K=2^{p} is the maximum number of complementary sets of orthogonal sequences among them; {c_{1,n}[i],c_{2,n}[i], . . . c_{K,n}[i]} are a set of complementary sequences with a length 2^{N}; δ[i] is the Kronecker delta function; i is a whole number that represents the scale of time; n is the iteration number, Dₙ is a delay element, Pₙ, n=1, 2, . . . , 2^{N}, is any permutation of the numbers {0, 1, 2, . . . , N−1}; and {w_{1,n}, w_{2,n}, . . . , w_{p,n}} are P vectors of coefficients with length N where each w_{x,y} is an arbitrary unit magnitude complex number;

20. The method according to claim 2 wherein the sequences are detected or correlated according to the following algorithm:
$${c}_{1 , n} [ i ] = {c}_{1 , n - 1} [ i ] + {w}_{1 , n} {c}_{2 , n - 1} [ i - {D}_{n} ] + {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] + … … + {w}_{1 , n} {w}_{2 , n} … {w}_{p , n} {c}_{K , n - 1} [ i - ( K - 1 ) {D}_{n} ] \\ {c}_{2 , n} [ i ] = {c}_{1 , n - 1} [ i ] - {w}_{1 , n} {c}_{2 , n - 1} [ i - {D}_{n} ] + {w}_{2 , n} {c}_{3 , n - 1} [ i - 2 {D}_{n} ] - {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] - {w}_{1 , n} {w}_{p , n} {c}_{K , n - 1} [ i - ( K / 2 ) {D}_{n} ] - … … - {w}_{1 , n} {w}_{2 , n} … {w}_{p , n} {c}_{K , n - 1} [ i - ( K - 1 ) {D}_{n} ] \\ {c}_{3 , n} [ i ] = {c}_{1 , n - 1} [ i ] + {w}_{1 , n} {c}_{2 , n - 1} [ i - {D}_{n} ] - {w}_{2 , n} {c}_{3 , n - 1} [ i - 2 {D}_{n} ] - {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] + … … - {w}_{1 , n} {w}_{2 , n} … {w}_{p , n} {c}_{K , n - 1} [ i - ( K - 1 ) {D}_{n} ] \\ {c}_{4 , n} [ i ] = {c}_{1 , n - 1} [ i ] - {w}_{1 , n} {c}_{2 , n - 1} [ i - {D}_{n} ] - {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … … + {w}_{p , n} {c}_{K , n - 1} [ i - ( K / 2 - 1 ) {D}_{n} ] - {w}_{1 , n} {w}_{p , n} {c}_{K , n - 1} [ i - ( K / 2 ) {D}_{n} ] + … … + {w}_{1 , n} {w}_{2 , n} … {w}_{p , n} {c}_{K , n - 1} [ i - ( K - 1 ) {D}_{n} ] \\ … \\ {c}_{K , n} [ i ] = {c}_{1 , n - 1} [ i ] - {w}_{1 , n} {c}_{2 , n - 1} [ i - {D}_{n} ] - {w}_{2 , n} {c}_{3 , n - 1} [ i - 2 {D}_{n} ] + {w}_{1 , n} {w}_{2 , n} {c}_{4 , n - 1} [ i - 3 {D}_{n} ] + … … - {w}_{p , n} {c}_{K , n - 1} [ i - ( K / 2 - 1 ) {D}_{n} ] + {w}_{1 , n} {w}_{p , n} {c}_{K , n - 1} [ i - ( K / 2 ) {D}_{n} ] - … … - {w}_{1 , n} {w}_{2 , n} … {w}_{p , n} {c}_{K , n - 1} [ i - ( K - 1 ) {D}_{n} ]$$
where i=0, 1, 2, 3, . . . , 2^{N}−1; n=1, 2, . . . N; Dₙ=K^{P}^{ₙ}; K=2^{p} is the maximum number of complementary sets of orthogonal sequences among them; {c_{1,n}[i],c_{2,n}[i], . . . c_{K,n}[i]} are a set of complementary sequences with a length 2^{N}; δ[i] is the Kronecker delta function; i is a whole number that represents the scale of time; n is the iteration number, Dₙ is a delay element, Pₙ, n=1, 2, . . . , 2^{N}, is any permutation of the numbers {0, 1, 2, . . . , N−1}; and {w_{1,n}, w_{2,n}, . . . , w_{p,n}} are P vectors of coefficients with length N where each w_{x,y} is an arbitrary unit magnitude complex number;

21. The method according to claim 2 wherein the sequences are detected or correlated according to the following algorithm:
$${c}_{1 , 0} [ i ] = {c}_{2 , 0} [ i ] = {c}_{3 , 0} [ i ] = … = {c}_{M , 0} [ i ] = δ [ i ]$$
$${c}_{1 , n} [ i ] = {c}_{1 , n - 1} [ i ] + {w}_{1 , n} {c}_{2 , n - 1} [ i - ( K - 1 ) {D}_{n} ] + {w}_{2 , n} {c}_{3 , n - 1} [ i - ( K - 2 ) {D}_{n} ] + {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] + {w}_{1 , n} {w}_{p , n} {c}_{K , n - 1} [ i - ( K / 2 - 3 ) {D}_{n} ] + … … + {w}_{1 , n} {w}_{2 , n} … {w}_{p , n} {c}_{K , n - 1} [ i ]$$
$${c}_{2 , n} [ i ] = {c}_{1 , n - 1} [ i ] - {w}_{1 , n} {c}_{2 , n - 1} [ i - ( K - 1 ) {D}_{n} ] + {w}_{2 , n} {c}_{3 , n - 1} [ i - ( K - 2 ) {D}_{n} ] - {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] - {w}_{1 , n} {w}_{p , n} {c}_{K , n - 1} [ i - ( K / 2 - 3 ) {D}_{n} ] - … … - {w}_{1 , n} {w}_{2 , n} … {w}_{p , n} {c}_{K , n - 1} [ i ]$$
$${c}_{3 , n} [ i ] = {c}_{1 , n - 1} [ i ] + {w}_{1 , n} {c}_{2 , n - 1} [ i - ( K - 1 ) {D}_{n} ] - {w}_{2 , n} {c}_{3 , n - 1} [ i - ( K - 2 ) {D}_{n} ] - {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] + {w}_{1 , n} {w}_{p , n} {c}_{K , n - 1} [ i - ( K / 2 - 3 ) {D}_{n} ] + … … - {w}_{1 , n} {w}_{2 , n} … {w}_{p , n} {c}_{K , n - 1} [ i ]$$
$${c}_{4 , n} [ i ] = {c}_{1 , n - 1} [ i ] - {w}_{1 , n} {c}_{2 , n - 1} [ i - ( K - 1 ) {D}_{n} ] - {w}_{2 , n} {c}_{3 , n - 1} [ i - ( K - 2 ) {D}_{n} ] + {w}_{1 , n} {w}_{2 , n} {c}_{4 , n - 1} [ i - ( K - 3 ) {D}_{n} ] + … … + {w}_{p , n} {c}_{K , n - 1} [ i - ( K / 2 - 2 ) {D}_{n} ] - {w}_{1 , n} {w}_{p , n} {c}_{K , n - 1} [ i - ( K / 2 - 3 ) {D}_{n} ] + … … + {w}_{1 , n} {w}_{2 , n} … {w}_{p , n} {c}_{K , n - 1} [ i ]$$
$$…$$
$${c}_{K , n} [ i ] = {c}_{1 , n - 1} [ i ] - {w}_{1 , n} {c}_{2 , n - 1} [ i - ( K - 1 ) {D}_{n} ] - {w}_{2 , n} {c}_{3 , n - 1} [ i - ( K - 2 ) {D}_{n} ] + {w}_{1 , n} {w}_{2 , n} {c}_{4 , n - 1} [ i - ( K - 3 ) {D}_{n} ] + … … - {w}_{p , n} {c}_{K , n - 1} [ i - ( K / 2 - 2 ) {D}_{n} ] + {w}_{1 , n} {w}_{p , n} {c}_{K , n - 1} [ i - ( K / 2 - 3 ) {D}_{n} ] - … … - {w}_{1 , n} {w}_{2 , n} … {w}_{p , n} {c}_{K , n - 1} [ i ]$$
where i=0, 1, 2, 3, . . . , 2^{N}−1; n=1, 2, . . . N; Dₙ=K^{P}^{ₙ}; K=2^{p} is the maximum number of complementary sets of orthogonal sequences among them; {c_{1,n}[i],c_{2,n}[i], . . . c_{K,n}[i]} are a set of complementary sequences with a length 2^{N}; δ[i] is the Kronecker delta function; i is a whole number that represents the scale of time; n is the iteration number, Dₙ is a delay element, Pₙ, n=1, 2, . . . , 2^{N}, is any permutation of the numbers {0, 1, 2, . . . , N−1}; and {w_{1,n}, w_{2,n}, . . . , w_{p,n}} are P vectors of coefficients with length N where each w_{x,y} is an arbitrary unit magnitude complex number;

22. The method according to claims 18 wherein {w_{1,n}, w_{2,n}, . . . , w_{p,n}} only take the values +1 and −1 to facilitate implementation of the algorithm using only additions and subtractions.

23. The method according to claims 12 wherein the complementary sequences are generated previously and stored in memory and transmitted as said memory is read.

24. The method according to claims 1 wherein the sets of complementary sequences are orthogonal among each other including the crossed correlations comma is null for any movement.

25. The method according to claims 1 wherein the correlation process is implemented efficiently to reduce the number of steps or blocks necessary to obtain the correlation or generation.

26. The method according to claim 1 wherein the correlation process is implemented efficiently to reduce the quantity of memory necessary to obtain the correlation or generation.

27. The method according to claim 1 wherein any type of modulation is used to transmit and receive the complementary sequences.

28. The method according to claim 1 wherein any transformed sequence is used to transform the complementary sequences from timing to frequency.

29. The method according to claim 11 wherein various antennas comprising a multiple input, multiple output system are used.

30. The method according to claim 29 wherein detection is used to estimate the channel response, thereby allowing efficient equalization and decreasing the radio signal mix of the various trajectories to the maximum extent.

31. The method according to claim 12 where in several cables are used to transmit and receive data.

32. The method according to claim 31 wherein detection is used to estimate the channel response, thereby allowing efficient equalization and decreasing diaphony to the maximum extent.

33. The method according to claim 1 wherein the dynamic scale of the structure for values of 2≦K≦N is realized by using switching elements.

34. A method of forming a preamble to be used to estimate the means of transmission based on simultaneous transmission of K sets of complementary sequences in systems with K inputs and K outputs.

35. The method according to claim 34 wherein, in each input, a set of separate complementary sequences is transmitted simultaneously, sequentially and orthogonally to the complementary sets of sequences transmitted in the rest of the inputs, observing the same order of sequences in each of the inputs.

36. The method according to claim 35 wherein separations are introduced between each of the sequences or between the sequences and the rest of the message data transmitted.
